(19) United States
(12) Patent Application Publication
(10) Pub. No.: US 2007/0252863 A1
(43) Pub. Date: Nov. 1, 2007

(54) Methods and apparatus for maintaining inkjet print heads using parking structures with spray mechanisms

(76) Inventors: Lizhong Sun, (US); Quanyuan Shang, (US)

Correspondence Address: DUGAN & DUGAN, PC, 55 SOUTH BROADWAY, TARRYTOWN, NY, 10591, US

(21) Appl. No.: 11/493,310

(22) Filed: Jul. 26, 2006

Related U.S. Application Data
(60) Provisional application No. 60/795,709, filed on Apr. 29, 2006.

(51) Int. Cl. B41J 2/165

(52) U.S. Cl. 347/28

(57) ABSTRACT

The invention provides a print head parking structure that provides solvent and/or surface treatments for inkjet print heads. Print heads may be returned to the print head parking structure after a substrate has been printed, after one or more printing passes, and/or frequently enough to prevent ink from drying on or clogging the print heads. Once sealed within the print head parking structure, the print heads (or a portion thereof) may be sprayed with a solvent to dissolve or wash away any ink that has been deposited on the print heads.

The present application claims priority to U.S. Provisional Patent Application Ser. No. 60/795,709, filed on Apr. 29, 2006 and entitled “METHODS AND APPARATUS FOR MAINTAINING INKJET PRINTHEADS USING PARKING STRUCTURES,” both of which are hereby incorporated by reference herein for all purposes.

### CROSS-REFERENCE TO RELATED APPLICATIONS

The present application is related to:

U.S. patent application Ser. No. 11/061,148, filed on Feb. 18, 2005 and entitled “METHODS AND APPARATUS FOR INKJET PRINTING OF COLOR FILTERS FOR DISPLAYS” (Attorney Docket No. 9521-5);

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L);

U.S. patent application Ser. No. 11/238,631 filed Sep. 29, 2005 and entitled “METHODS AND APPARATUS FOR INKJET PRINT HEAD CLEANING” (Attorney Docket No. 9838); and

U.S. Provisional Patent Application Ser. No. 60/721,340 filed Sep. 27, 2005 and entitled “INKJET DELIVERY MODULE” (Attorney Docket No. 10145/L), which are each hereby incorporated herein by reference in its entirety for all purposes.

### FIELD OF THE INVENTION

The present invention relates generally to inkjet printing systems employed during flat panel display formation, and is more particularly concerned with apparatus and methods for maintaining inkjet print heads.

### BACKGROUND OF THE INVENTION

The flat panel display industry has been attempting to employ inkjet printing to manufacture display devices, in particular, color filters. However, inkjet print heads used in inkjet printing may become filled with ink, clogged, coated, or otherwise rendered unsuitable for use in an inkjet printing process. Conventional methods for cleaning inkjet print heads involve a manual wiping process. This process often includes bringing inkjet print heads offline and away from a clean production environment, is slow and may damage or shift a print head from a desired print position. Accordingly, improved methods and apparatus for maintaining an inkjet print head are desired.

### SUMMARY OF THE INVENTION

In certain aspects of the invention, a print head parking structure includes an enclosure including a spray device; and a parking location adjacent the enclosure and adapted to receive a print head such that the print head is exposed to the spray device within the enclosure.

In other aspects of the present invention, a method is provided that includes sealing a print head within a parking structure; and spraying a nozzle plate of the print head with a solvent without getting the solvent on other parts of the print head.

In yet other aspects of the present invention, a system is provided that includes an inkjet printer adapted to manufacture color filters for flat panel displays, the inkjet printer including a plurality of print heads, each print head including a nozzle plate; and a print head parking structure including an enclosure having a spray device and a parking location adapted to receive a print head such that the nozzle plate of a received print head is exposed to the spray device within the enclosure.

Other features and aspects of the present invention will become more fully apparent from the following detailed description, the appended claims and the accompanying drawings.

### BRIEF DESCRIPTION OF THE DRAWINGS

FIG. 1 is a front perspective schematic view of an inkjet printing system according to some aspects of the present invention.

FIG. 2 is a close-up perspective view of a print head located above an example embodiment of a print head parking structure according to some aspects of the present invention.

FIG. 3 is a front plan schematic view of a print head parked in an example parking structure according to some aspects of the present invention.

FIG. 4A is a cross-sectional front plan schematic view of a print head parked in an example parking structure according to some aspects of the present invention.

FIG. 4B is a bottom plan schematic view of the print head parked in the parking structure shown in FIG. 4A.

FIG. 5A is a perspective schematic view of a sprayer arrangement and print head in a parking structure according to an aspect of the present invention.

FIG. 5B is a bottom plan schematic view of the sprayer arrangement and print head shown in FIG. 5A.

FIG. 6A is a bottom plan schematic view of an alternative sprayer arrangement and print head in a parking structure according to an aspect of the present invention.

FIG. 6B is a bottom plan schematic view of another sprayer arrangement and print head in a parking structure according to an aspect of the present invention.

FIG. 7A is a cross-sectional front plan schematic view of a print head parked in an example parking structure according to another aspect of the present invention.

FIG. 7B is a cross-sectional front plan schematic view of a print head parked in an example parking structure according to another aspect of the present invention.

FIG. 8 is a flowchart depicting an example process of employing a parking structure according to some aspects of the present invention.

FIG. 9 is a flowchart depicting an example process of using an inkjet printing system according to some aspects of the present invention.

### DETAILED DESCRIPTION

The nozzles of inkjet printer heads used in the manufacture of color filters for flat panel displays may become clogged or otherwise obstructed by ink drying on or in the print heads. While various methods of maintaining and purging the nozzles may be employed to remove dried ink, methods that may eliminate or reduce the amount of ink that dries on the print heads may use a print head parking structure that includes sprayers which apply a solvent to the nozzles and/or surface treatment for the print heads.

In another maintenance technique, the print heads are bathed for a duration in a solvent. This technique has proven to be an advance in the art; however, in some instances, the solvent bath may become contaminated from the quantities of ink which are removed and absorbed. The contaminated solvent may dry on or adhere to the print head nozzles, and thus the solvent bath may, in these circumstances, reintroduce the problem intended to be solved. The inventors of the present invention have determined that spraying alone or spraying after a solvent bath avoids this problem.

In operation, the print heads may be returned to the print head parking structure after a substrate has been printed, after one or more printing passes, and/or frequently enough to prevent ink from drying on or clogging the print heads. Once within the print head parking structure, the surface of the print heads (or a portion thereof) may be sprayed with a solvent to maintain surface conditions. The solvent spray drips off the print heads taking the dissolved ink and is caught in a bath container. Alternatively, the print heads may be lowered into a solvent bath, the bath may be drained (or the print heads raised above the contaminated solvent), and then the print heads may be sprayed with clean solvent.

In some embodiments, one or more sprayers convey solvent over a wide area to cover the nozzle plate surfaces of the print heads. The one or more sprayers may be movable to increase their spray coverage and apply the solvent at different angles to loosen contaminants. The print heads themselves may also be caused to jet solvent into the bath container to purge any ink within the nozzles. Alternatively or additionally, the print head parking structure may include other nozzles for applying, e.g., clean dry air (CDA) to the print heads to remove any excess solvent from the print heads before the heads are again used for printing.

In some embodiments, the print head parking structure may be used to apply a surface treatment to the print heads and/or the nozzles of the print heads. The print heads and/or nozzles may be sprayed or otherwise coated with a chemical or treatment selected to make the surfaces of the print heads and/or nozzles inkphobic which causes ink to tend not to wet (e.g., bead on) the surfaces. In some embodiments, the surface treatment and the solvent may be combined into one solution. In some embodiments, the solution may be applied to the nozzle plates of the print heads, the solution may be allowed to drip into a bath, and the solution may be recovered and recycled. In such embodiments, the solution may be filtered before the solution is reused.

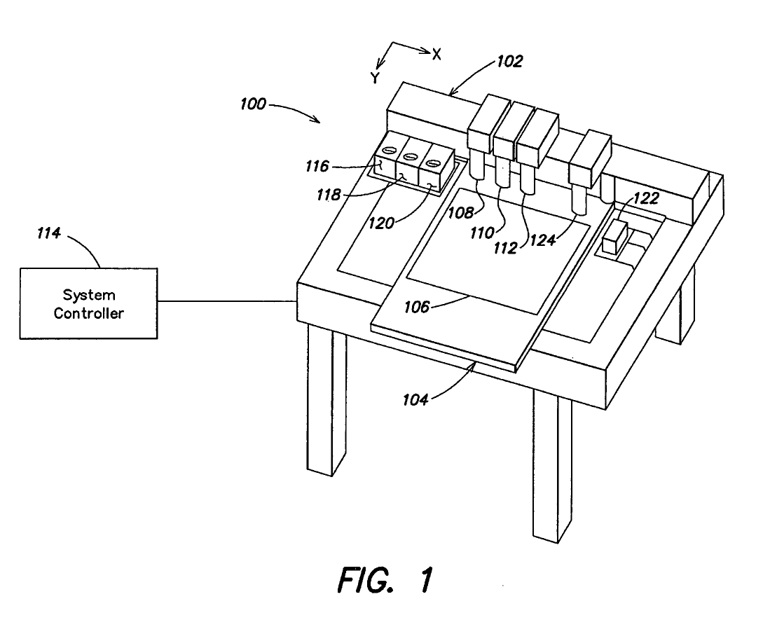

FIG. 1 illustrates a front perspective view of an embodiment of an inkjet printing system of the present invention which is designated generally by reference numeral 100. The inkjet printing system 100 of the present invention, in an exemplary embodiment, may include a print bridge 102. The print bridge 102 may be positioned above and/or coupled to a stage 104. The stage 104 may support a substrate 106. Supported on print bridge 102 may be print heads 108, 110, 112. Print heads 108, 110, 112 and print bridge 102 may be coupled (e.g., logically and/or electrically) to a system controller 114. The inkjet printing system 100 of the present invention may also include one or more print head parking stations 116, 118, 120 and one or more print head cleaning stations 122.

In the exemplary embodiment of FIG. 1, the print bridge 102 may be supported above the stage 104 in such a manner as to facilitate inkjet printing. The print bridge 102 and/or stage 104 may be movable each independently in both the positive and negative X- and Y-directions as indicated by the X- and Y-direction arrows in FIG. 1. In the same or alternative embodiments print bridge 102 and stage 104 may be rotatable. The print bridge 102 may be capable of supporting and moving any number of print heads 108, 110, 112 and/or other devices (e.g., sensors, imaging system, range finder, etc.). The substrate 106 may sit atop or, in some embodiments, be coupled to the movable stage 104.

Although only three print heads 108, 110, 112 are shown on print bridge 102 in FIG. 1, it is important to note that any number of print heads may be mounted on and/or used in connection with the print bridge 102 (e.g., 1, 2, 4, 5, 6, 7, etc. print heads). Print heads 108, 110, 112 may each be capable of dispensing a single color of ink or, in some embodiments, may be capable of dispensing multiple colors of ink. Inkjet print heads 108, 110, 112 may be movable and/or alignable vertically, horizontally and/or rotationally so as to enable accurate inkjet drop placement. The print bridge 102 may also be movable and/or rotatable to position print heads 108-112 for accurate inkjet printing. In operation, the inkjet print heads 108, 110, 112 may dispense ink (e.g., from nozzles) in drops.

Examples of commercially available print heads suitable for use with the present invention are the model S-128 Series 128-Channel Jetting Assemblies manufactured by Spectra, Inc. of Lebanon, N.H. These particular jetting assemblies include two electrically independent piezoelectric slices, each with sixty-four addressable channels, which are combined to provide a total of 128 jets. The print head includes a nozzle plate having a number of nozzles which are arranged in a line, at approximately 0.020″ distance between nozzles. Other print heads with differently sized nozzles may also be used. The nozzles may comprise orifices in the nozzle plate 150 or may comprise protrusions with openings that extend from the nozzle plate. In some embodiments, gold plated or gold coated print heads/nozzles may be used to help reduce wetting of the print heads/nozzles, particularly in conjunction with inkphobic surface treatments. Less wetting results in improved jetting performance by improving jetting reliability and drop size repeatability.

In some embodiments, an imaging system 124 capable of capturing images of the substrate 106, ink drops released from print heads 108, 110, 112, and/or nozzles of the print heads 108, 110, 112, may be included in the inkjet printing system 100. Such an imaging system 124 may be adapted to be capable of capturing images of sufficient quality to discern ink drops of about 2 um to about 100 um in diameter. Accordingly, the imaging system 124 may include a telescope zoom lens and may have high resolution (e.g., at least about 1024×768 pixels). Other camera types and/or resolutions may also be used. The imaging system 124 may also be equipped with motorized/automated aiming, zooming, and/or focusing features. In operation, the imaging system 124 may be used to inspect nozzles of the print heads 108, 110, 112 to determine if the nozzles may benefit from a cleaning and/or an inkphobic surface treatment (e.g., because ink appears to have built-up or dried on the nozzles, clean solvent flowed through the nozzles is not clear or has ink color, and/or ink appears to no longer bead on the surface of the nozzles/print heads).

The print bridge 102, stage 104, and/or inkjet print heads 108, 110, 112 may be coupled to system controller 114. System controller 114 may be adapted to control motion of the print bridge 102, the stage 104, and/or the inkjet print heads 108, 110, 112 in inkjet printing operations. System controller 114 may also control firing pulse signals for inkjet print heads 108, 110, 112. The system controller 114 may comprise a single controller or multiple controllers.

The print head parking stations 116, 118, 120 may be disposed below the level of the stage 104 and may be adapted to each individually be raised up independently to receive a print head 108, 110, 112. In some embodiments, the system 100 may include one print head parking station 116, 118, 120 per print head 108, 110, 112. In additional or alternative embodiments, one parking station 116 may be used with multiple print heads 108, 110, 112 or multiple parking stations 116, 118, 120 may be used with a single print head 108. For example, a first parking station 116 may be adapted to spray a print head 108 with solvent, a second parking station 118 may be adapted to dry the print head 108 with compressed air, and a third parking station may be adapted to coat the print head with an inkphobic surface treatment. Likewise, a single parking station 116 may be adapted to perform all three of the above example functions in addition to other maintenance, cleaning, and/or protection functions on one or more print heads 108, 110, 112. Thus, in various embodiments, any number of print heads 108, 110, 112 may be serviced or maintained by the performance of any number functions by any number of parking stations 116, 118, 120.

One or more print head wiping stations 122 may also be disposed in the same or similar manner and locations as the print head parking stations 116, 118, 120. Previously incorporated U.S. patent application Ser. No. 11/238,631 describes in detail many features and aspects of an example of a print head cleaning station suitable for use with the present inkjet printing system 100.

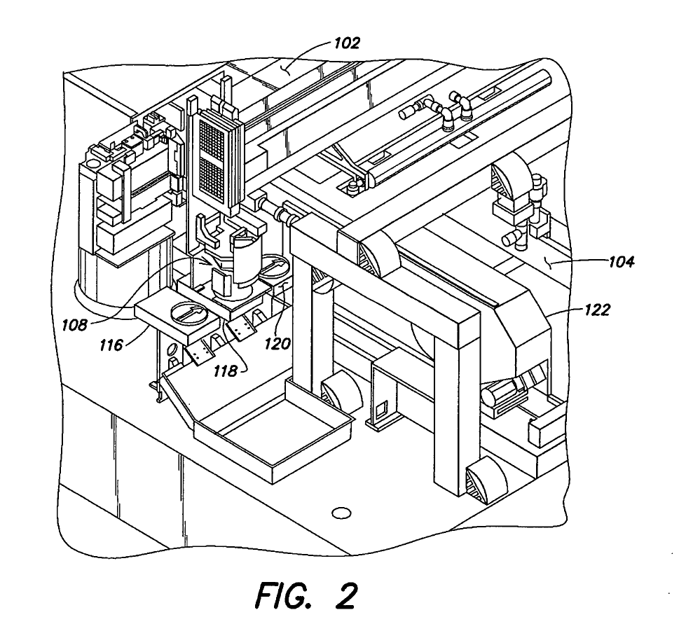

Turning to FIG. 2, a close-up perspective view of a print head 108 located above a center one of three example embodiments of print head parking structures 116, 118, 120 is depicted. In contrast to FIG. 1, the print head 108 is shown parked within one of the parking structures 118. Note that in some embodiments, the print head parking structures 116, 118, 120 may be disposed adjacent one side of the stage 104. Alternatively or additionally, parking structures may be disposed at both sides, the front, and/or rear of the stage 104. Such embodiments are adapted to facilitate use of the parking structures while minimizing the time and/or distance over which the print heads would have to be moved to reach the parking structures.

The print head parking structures 116, 118, 120 may be adapted to rise up to engage the print heads 108, 110, 112 at or above the level of the stage 104. In addition, the parking structures 116, 118, 120 may be adapted to be lowered to, or below, the level of the stage 104 to provide clearance to move the print heads 108, 110, 112 laterally over the recessed parking structures 116, 118, 120. In some embodiments, the parking structures 116, 118, 120 may have a fixed vertical position and the print heads 108, 110, 112 may be adapted be lowered and raised to engage and disengage the parking structures 116, 118, 120.

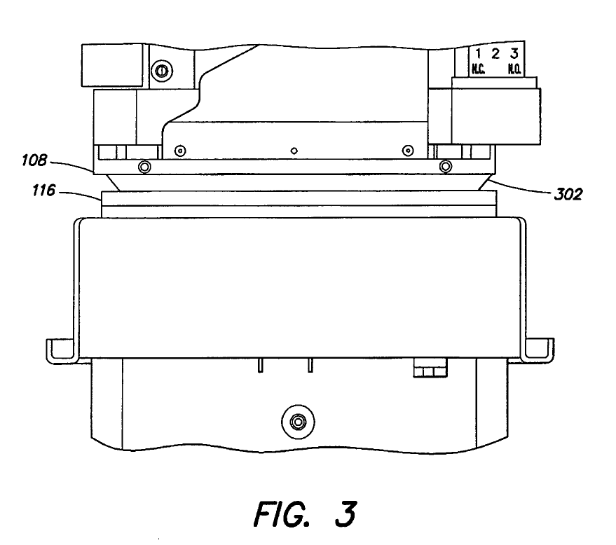

Turning to FIG. 3, a front plan view of a print head 108 parked in an example parking structure 116 is depicted. The parking structure 116 includes a seal 302 that is adapted to receive the lower portion of the print head 108 including nozzle plate 150. The seal 302 contacts a flat portion of the surface of the print head 108 such that solvent sprayed within the parking structure 116 is contained and prevented from emerging from the parking structure 116 while the print head 108 is parked (e.g., during a purge process). The seal 302 may be embodied as a flexible bellows adapted to be compressed and to conform to the surface of the print head 108 when either the parking structure 116 is raised to engage the print head 108 or the print head 108 is lowered into the parking structure 116. The seal 302 may be made from any number of materials including rubber, plastics, thin sheet metal, flexible or semi-rigid polyvinylchloride (PVC), or any practicable material that is compressible to form a seal and not reactive with inks, solvents, print head surface treatments, and/or any other chemical or process that may be used with the parking structure 116. The parking structure 116 may include a drain line 406 to remove solvent and/or ink that may accumulate in the structure after spraying or purging. The drain line 406 may lead to a waste disposal facility, or, in some embodiments, the drain line 406 may direct the used solvent/surface treatment solution(s) back to a solution recycling system (not shown). A solution recycling system may filter ink and any other contaminants from the used solution and return the cleaned solution back to the fluid supply reservoir (not shown). In some embodiments, the recovered solution may not need to be filtered before it is reused.

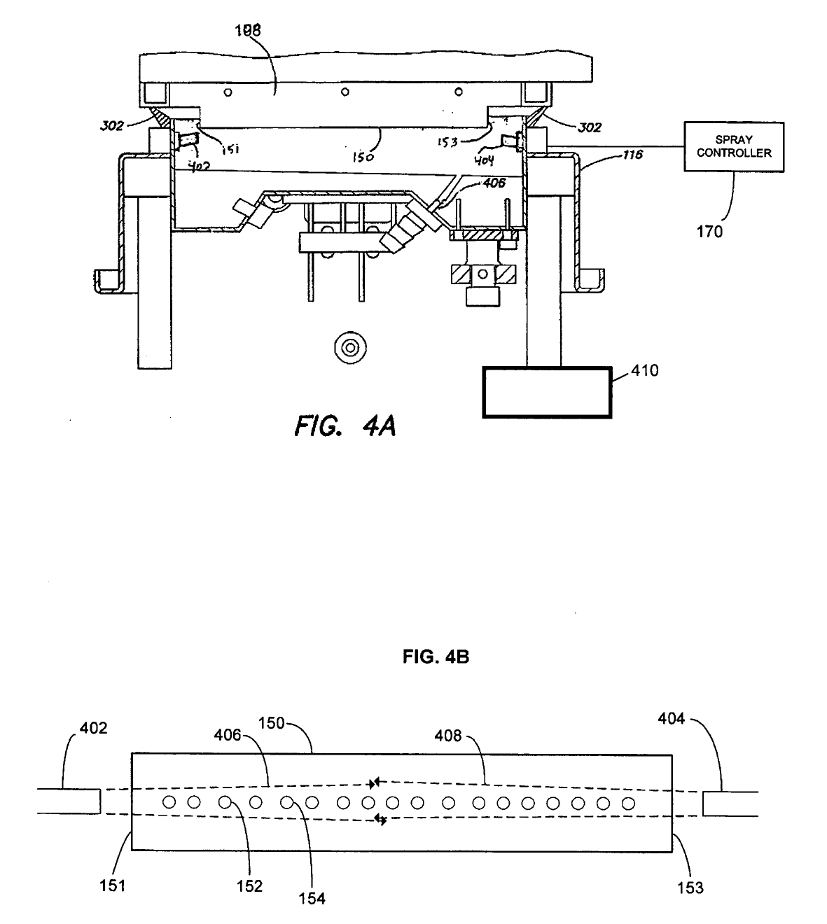

Turning to FIG. 4A, an exemplary cross-sectional front view of a print head 108 parked in an example parking structure 116 is depicted. The example parking structure 116 depicted in FIG. 4A includes sprayers 402, 404 adapted to spray solvent and/or surface treatment chemicals onto the nozzle plate 150 of the print head 108 without getting solvent on the sides of the print head 108. It is noted that while only two sprayers 402, 404 are shown in the particular example of FIG. 4A, the parking structure may include any number of sprayers (e.g., 1, 2, 3, 4, 5, 6, 7, etc.) and the sprayers 402, 404 may be situated with respect to the nozzles of the print head 108 in a number of different arrangements. In the arrangement depicted in FIG. 4A, the sprayers 402, 404 are positioned proximate to and slightly below opposite lateral ends 151, 153 of the nozzle plate 150 and configured to direct a stream of solvent with a small angular spread.

As indicated above, the parking structure 116 may be adapted to move vertically to engage and disengage a print head 108. In some embodiments, an actuator 410 (e.g., a pneumatic or hydraulic cylinder either alone or in conjunction with a cam or up/down rotation shaft) may be employed to raise and lower the parking structure 116.

FIG. 4B is a bottom plan view of an example embodiment of a print head in a parking structure as shown in FIG. 4A. As can be discerned, in their respective positions, each of the sprayers 402, 404 may have a spray exposure 406, 408 of (at least) the respective half of the nozzle plate surface 150 to which they are proximate so that the entire surface of the nozzle plate can be contacted with solvent spray. In an example embodiment, the sprayers 402, 404 are controlled to collectively provide solvent and/or surface treatment solution at a rate of approximately 5 to 20 ml/minute over an area, for example, of approximately 6 cm long by 0.5 cm wide. In some embodiments, the sprayers 402, 404 may each provide an intermittent or pulsed spray at a rate of approximately 3 to 6 pulses per minute. The spraying may be applied continuously in a pulsed manner during the entire time the head is parked. Other volumes of solvent/surface treatment, pressures of solvent/surface treatment, spray exposure areas, and pulse rates may be employed.

The sprayers 402, 404 are coupled to a fluid supply reservoir (not shown) via one or more valves (also not shown). The sprayers 402, 404 are also coupled to a spray controller 170. Spray controller 170 may be adapted to control motion of and provision of fluid to the sprayers 402, 404. The spray controller 170 may also control trigger signals for activating the sprayers 402, 404 to spray solvent onto the nozzles of the print head 108. The spray controller 170 may transmit trigger signals to activate the sprayers 402, 404 continuously for a specified duration or intermittently in discrete pulses spaced apart by a fixed or variable duration. The spray controller 170 may comprise a single controller or multiple controllers.

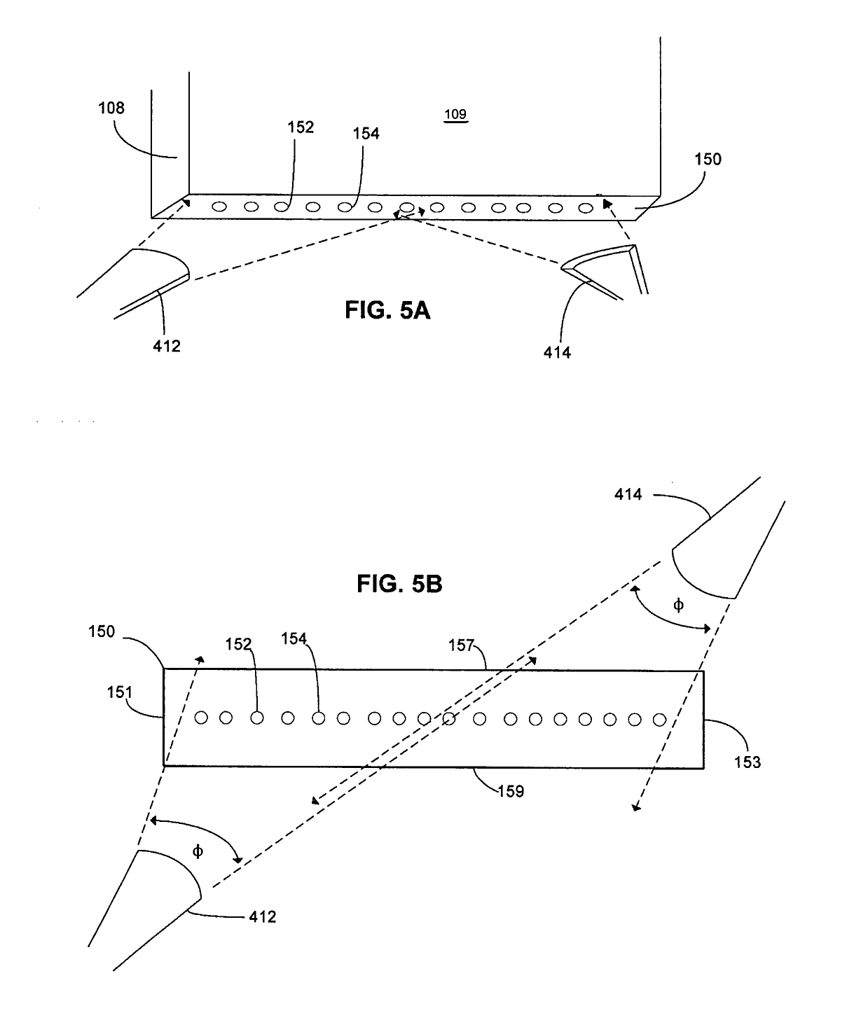

FIGS. 5A and 5B are perspective and bottom plan views respectively of an alternative and/or additional embodiment of an arrangement for applying solvent to a print head in which sprayers 412, 414 are arranged proximate to the longitudinal sides 157, 159 adapted to spray solvent over a spray angle φ. It is again noted that the different numbers of sprayers and different arrangements may be employed to spray the nozzle plate 150 of the print head 108 without getting solvent on the sides of the print head 108. The sprayers 412, 414 may each include a slit valve and/or fan-shaped spray nozzle adapted to increase the spray angle φ at which solvent is sprayed. In the example embodiment depicted, the spray angle φ is between 45 and 75 degrees, and the respective central axes of sprayers 412, 414 are arranged at an acute angle with respect to the longitudinal axis of nozzle plate 150 to facilitate exposure of the entire nozzle plate surface to sprayed solvent. In this context, at higher spray angles φ, for example, 90 degrees or above, the central axes of the sprayers 412, 414 may be oriented at correspondingly higher angles with respect to the longitudinal axis of the nozzle plate 150. It is understood that different numbers of sprayers and different sprayer arrangements may be used.

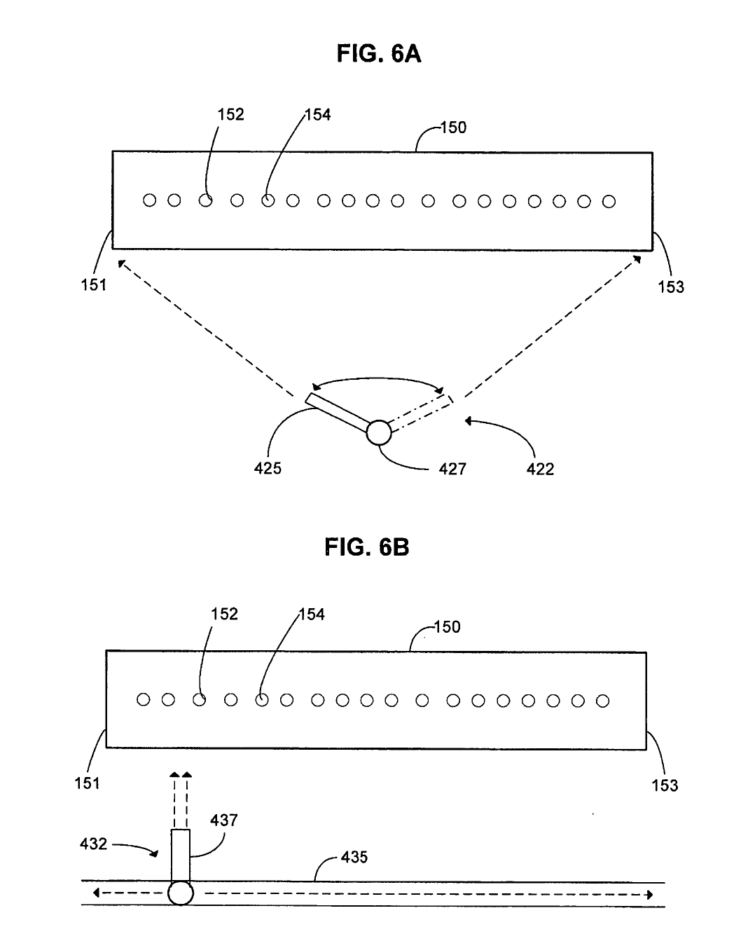

FIG. 6A shows a bottom plan view of an alternative and/or additional embodiment of an arrangement for applying solvent to a print head nozzle plate 150 in which a sprayer 422 having a nozzle 425 adapted to eject spray at an approximately linear trajectory can be controllably pivoted around a fixed end 427. In operation, the central axis of the nozzle can be selectively directed in a range from one lateral end 151 of the nozzle plate to the other lateral end 153. The fixed end 427 may comprise any coupling, joint or fixture that allows (at least) rotational movement in the plane of the nozzle plate 150. For example, the fixed end 427 may include a ball and socket joint that enables further adjustments in addition to rotational movement to compensate for possible positional offsets. In operation, the spray controller 170 may send electrical signals to activate the sprayer 422 to pivot and eject solvent continuously in successive spray arcs, and/or may send signals that the cause the spray to pivot, stop and spray in discrete incremental steps. It is again noted that while only one sprayer is depicted, a plurality of sprayers with the same or different pivoting mechanisms may be used.

FIG. 6B shows a bottom plan view of still another alternative and/or additional embodiment of an arrangement for applying solvent to a print head nozzle plate 150 in which a sprayer 432 is adapted to translate along a path in order to expose the entire area of the nozzle plate 150 to solvent spray. The sprayer 432 may be coupled to a rail 435 and be driven by a motor (not shown) under direction of the spray controller 170 to move along the rail parallel to the longitudinal dimension of the nozzle plate 150. In this embodiment, like the embodiment shown in FIG. 6A, the spray may include a nozzle 437 adapted to eject an approximately linear stream of solvent in a direction approximately perpendicular to the longitudinal dimension of the nozzle plate; optimal exposure of the nozzle is achieved by moving the sprayer 432 continuously or in discrete increments along the rail 435, enabling spray to be directed toward the nozzle plate 150 along its entire length.

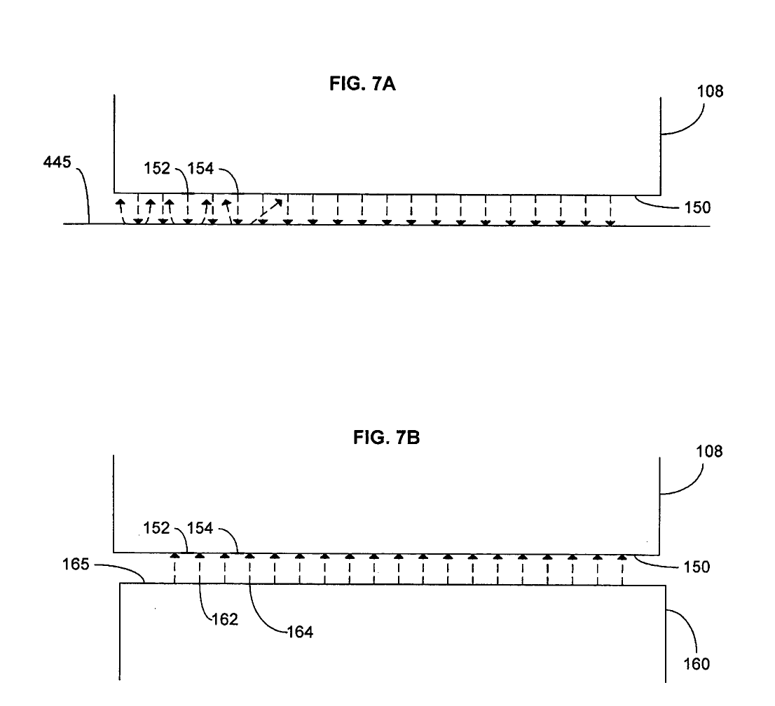

In additional and/or alternative embodiments shown in FIGS. 7A and 7B, a different solvent application process is used. In these embodiments, the ink nozzles e.g., 152, 154 of the nozzle plate 150 are flushed with solvent via a purging process in which solvent is circulated through the print head instead of ink. A purging process for print heads is described, for example, in previously incorporated U.S. Provisional Application Ser. No. 60/721,340 entitled “INKJET DELIVERY MODULE”. In FIG. 7A, which is a cross-sectional view of a print head 108 within a parking structure, solvent is ejected through the nozzles 152, 154 toward a rebounding surface 445 oriented parallel to and positioned proximate to the nozzle plate 150. The rebounding surface 445 may be made of any suitable elastic or inelastic material and may be raised (or the print head lowered) to a selected clearance distance from the nozzle plate 150. In operation, as solvent is forced through the nozzles 152, 154 of the nozzle plate 150 during a purging process, it strikes the rebounding surface 445 and a portion of the solvent reflects off of the surface 445 at various angles back onto the nozzle plate 150, and in particular, onto the portions of the nozzle plate 150 between the nozzles 152, 154.

In the cross-sectional view of FIG. 7B, a print head 108 is parked so as to align (or approximately align) with and face an array of nozzles 160 (e.g., a second print head) oriented oppositely with its nozzle plate 165 facing in an upward direction. The nozzle array 160 may be coupled to a fluid reservoir (not shown) to operate in purge mode so that solvent is eject through its nozzles e.g., 162, 164 onto the facing nozzle plate 150 of the parked print head 108. The relative alignment of the nozzle plates 150, 165 may be controlled so that there is a slight offset between the nozzle plates 150, 165; in this configuration the nozzles e.g., 162, 164 of the nozzle array 160 face the edges of the nozzles 152, 154 or portions of the nozzle plate 150 between the nozzles 152, 154. In some embodiments, the nozzle array 160 may embodied as an upward facing print head. In some embodiments the nozzle array 160 may move (e.g., oscillate) relative to the print head 108 so that multiple areas of the nozzle plate 150 may be sprayed from multiple angles.

In some embodiments, specific areas of the nozzle plate 150 may be targeted using particular nozzles 162, 164 of the nozzle array 160 based upon, e.g., information from the imaging system 124 (FIG. 1). For example, the imaging system 124 may determine that nozzle X on print head Y is likely clogged because ink is not being deposited by the print head along a particular column of pixel wells that correspond to nozzle X. Once print head Y is parked in the parking structure 116, solvent spray nozzles on a nozzle array 160 that are aligned to spray near nozzle X on the print head Y may be activated to spray near nozzle X to dissolve the clog.

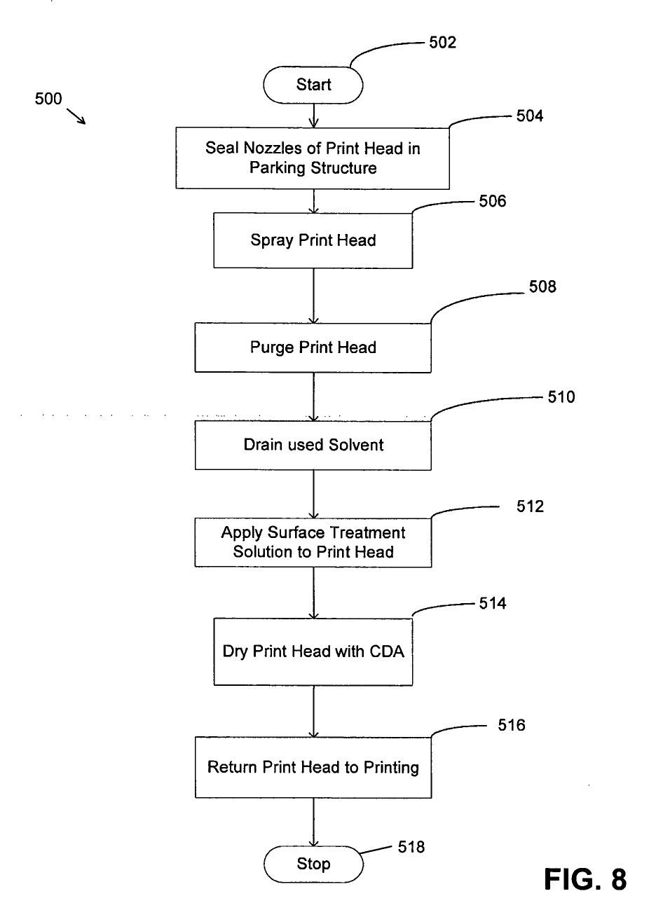

Turning to FIG. 8, an example method 500 of processing a print head 108 in a parking structure 116 is depicted. The method 500 commences at Step 502. In Step 504, the print head 108 is sealed in the parking structure 116. In operation, the system controller 114 may direct the system 100 to being the print head 108 to a park position above the parking structure 116 after completing, before starting, and/or during printing operations. The park position may be a known position that the inkjet printing system 100 stores in the memory of the system controller 114. In some embodiments, the park position may be determined or verified through the use of sensors or other devices disposed on the parking structures 116 and/or the print heads 108. Once the print head 108 is in the park position, the actuator 410 (FIG. 4A) may be directed by the system controller 114 to raise the parking structure 116 so that the seal 302 engages a surface of the print head 108.

In some embodiments, the actuator 410 may be adapted to allow the parking structure 116 to be held at different positions. A first position may be useful for spraying the print head nozzle plate 150 (e.g., with solvent or surface treatment, or with CDA, for example, to dry the print head 108) or for inspecting/testing the print head 108 while the print head is in the parking structure 116 (e.g., the output of the print head 108 maybe examined while solvent is jetted). A second position may be useful for other operations such as surface treatment. In either position, the seal 302 may maintain contact with the print head 108 so that ink, solvent, surface treatment solution, etc. remain contained in the parking structure 116. Thus, a camera (not shown) that is coupled to and/or part of the imaging system 124, may be disposed within the parking structure 116. Additionally or alternatively, the parking structure 116 may include a window (not shown) through which the print head 108 may be examined while in the parking structure 116.

Once the print head is sealed in the parking structure 116, the print head 108 may then be sprayed in Step 506. In some embodiments, the print head 108 may be dipped in a solvent bath before being sprayed. In Step 508, any remaining ink within the print head 108 may be purged by firing each of the nozzles of the print head 108 with the ink supply turned off. In some embodiments, the print head 108 may then be purged with solvent by jetting a solvent only solution through each of the nozzles of the print head 108. Generally, to purge ink from the print head 108, the inkjet print head 108 may force any remaining ink inside the print head 108 out of the print head 108 via any suitable method. As indicated above, this may include, for example, jetting ink and/or air through the print head 108. In one or more embodiments, ink and/or air may be jetted through the print head 108 using a pulse having a duration of about 0.5 seconds, although any other practicable pulse widths may be used. In an exemplary embodiment, print head 108 may purge between approximately three and six cubic centimeters of ink per cycle. The print head 108 may be purged onto a cleaning medium of a cleaning station 122 and/or into the parking structure 116 as described above.

After the nozzle plate 150 of the print head 108 (including the nozzles of the print head e.g., 152, 154) have been appropriately sprayed for a period of time, the parking structure may be drained of used solvent and dissolved ink via the drain line 406 in Step 510. In some embodiments the print head 108 may sprayed with solvent for a very short period. In other embodiments, the print head 108 may be sprayed for an extended period (e.g., minutes, hours, etc.). In some embodiments, the parking structure 116 may be lowered by the actuator 410 to allow an operator and/or the system 100 to examine (e.g., using an imaging system 124) and/or test the print head 108 to assess whether any ink remains on the print head 108. In some embodiments, the print head 108 may be moved from the parking structure to test/examine the print head 108. If ink remains, the print head 108 may be returned to a spraying position within the parking structure 116 for additional spraying and possibly for additional cycles of purging, spraying, inspecting, etc.

After solvent has been drained in Step 510, and while the print head 108 remains in (or has been returned to) the parking structure 116, the print head 108 may be sprayed with CDA to dry the print head 108. Once the print head 108 is dry, the parking station 116 may be lowered to disengage the seal 302 and the print head 108 may be ready to start, or return to, printing operations.

In some embodiments, before or after the print head 108 has been dried, in Step 512, print head may be treated with an inkphobic surface treatment solution. The print head 108 may not be dried before Step 512 in alternative embodiments. In some embodiments, heat may be also applied to the solution as part of the process of treating the print head 108. As with the solvent, in some embodiments the print head 108 may merely be sprayed with the inkphobic surface treatment solution for a very short period. In other embodiments, the print head 108 may be sprayed with the inkphobic surface treatment solution for an extended period (e.g., minutes, hours, etc.). After appropriate exposure to the surface treatment process, the print head 108 may be dried (e.g., using CDA) in Step 514, the parking structure may be lowered to disengage the seal 302, and the print head 108 may be ready to start, or continue, printing operations in Step 516. The method 500 ends at Step 518.

Aspects of the present invention include coating or treating the nozzle surfaces of the print head 108 with hydrophobic or inkphobic materials. The coatings improve jetting reliability and drop size repeatability. Many different types of coatings may be used depending on the types of inks employed and other factors. For example, a mixture of alkyl thiol and ionic alkyl thiol may be dissolved in a solvent to create the solution for a surface treatment. In some embodiments, for example, the ratio of alkyl thiol, ionic alkyl thiol in the solvent may be in the range of approximately 0.5˜5 mM:0.3˜5 mM. In some embodiments, the surface treatment solution may be made from any material whose molecules include either a sulfur atom or a nitrogen atom on the “active” end (e.g., the end of the molecule that bonds to the nozzle surfaces) and a carbon fluorine (e.g., CFx where x is any number) group of atoms on the other, inkphobic end of the molecule. Examples include: CF3(CF2)xCF2C2H4SH, such as 1H,1H,2H,2H-Perfluoro-1-decanethiol 3,3,4,4,5,5,6,6,7,7,8,8,9,9,10,10,10-Heptadecafluoro-1-decanethiol and 1H,1H,2H,2H-Perfluoro-1-hexanethiol 3,3,4,4,5,5,6,6,6-Nonafluoro-1-hexyl mercaptane.

In operation, the print heads 108 may be sprayed with the surface treatment solution at regular intervals (e.g., after one or more print passes, after print head cleaning, after a period of non-use, etc.). In some embodiments, the surface treatment solution may be employed to enhance other deposition processes in addition to printing color filters for flat panel displays.

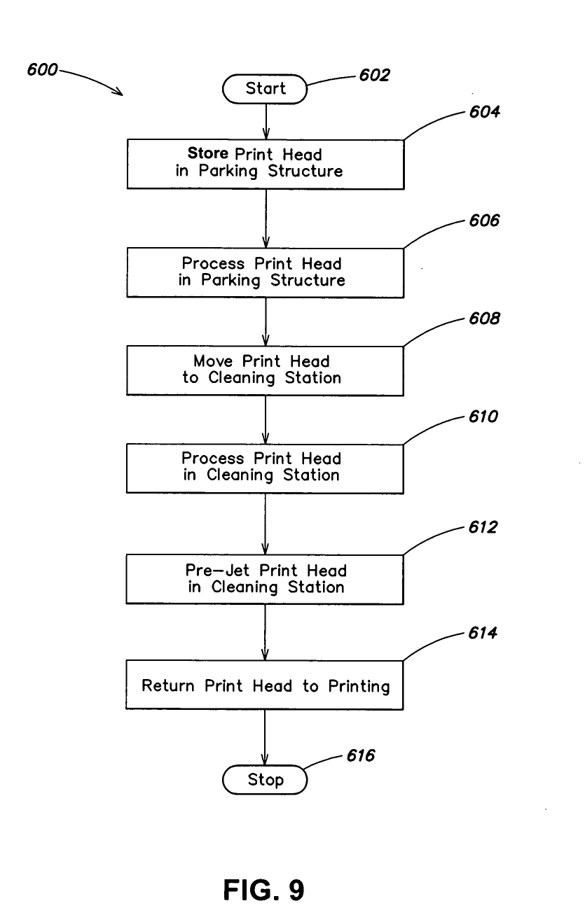

Turning to FIG. 9, a method 600 of printing operations is depicted. The method 600 starts at Step 602. In some embodiments, print heads 108, 110, 112 may remain sealed in respective parking structures 116, 118, 120 while a substrate 106 is loaded or removed from the stage. Thus, in Step 604, the print heads 108, 110, 112 are stored in the respective parking structures 116, 118, 120.

In Step 606, the print heads 108, 110, 112 may be processed in the respective parking structures 116, 118, 120 according to the methods described above and with respect to FIG. 8. For example, the print heads 108, 110, 112 may be sprayed with solvent within the parking structures 116, 118, 120. Further, the print heads 108, 110, 112 may be purged within the parking structures 116, 118, 120 and/or inspected. In some embodiments, the print heads 108, 110, 112 may receive a nozzle surface treatment in the respective parking structures 116, 118, 120 and/or be dried with CDA.

In some embodiments, in Step 608, one or more of the print heads 108, 110, 112 may next be moved to the cleaning station 122 where the print heads 108, 110, 112 may be further processed. For example, the print heads 108, 110, 112 may be wiped or otherwise conditioned as described in previously incorporated U.S. patent application Ser. No. 11/238,631. In Step 612, the heads 108, 110, 112 may also be pre-jetted at the cleaning station 122 to stabilize the ink pressure within the system 100.

In Step 614, the print heads 108, 110, 112 may be returned to a printing location so that printing may commence or continue. In alternative embodiments, the wiping at the cleaning station 122 may be performed before the surface treatment is applied to the nozzles at the parking structures 116, 118, 120. Between processing subsequent substrates, the print heads 108, 110, 112 may be returned to the respective parking structures 116, 118, 120. In alternative embodiments, various different sequences of using the parking structures 116, 118, 120 and the cleaning station 122 may be employed. For example, the print heads 108, 110, 112 may be returned to the respective parking structures 116, 118, 120 for a solvent or surface treatment spray after each printing pass. In Step 616, the method 600 ends.

The foregoing description discloses only exemplary embodiments of the invention; modifications of the above disclosed methods and apparatus which fall within the scope of the invention will be readily apparent to those of ordinary skill in the art. For instance, although the above example methods are generally described with reference to only one parking structure per print head as described above with reference to FIG. 1, one of ordinary skill in the art would understand that these methods may be applied with any suitable number of parking structures (e.g., 2, 3, 4, etc.).

In some embodiments, a parking structure 116 may be disposed in any practicable location, including mounted on a moveable platform such that the parking structure 116 may be brought to the print head 108 instead of the print head 108 having to be moved to the parking structure 116.

In some embodiments, the inkjet print head parking stations of the present invention may be mounted on and/or used with an inkjet printing system such as disclosed in previously incorporated U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING.” Further, the present invention may also be applied to processes for spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

What is claimed is:

1. A print head parking structure comprising:
an enclosure including a spray device; and
a parking location adjacent the enclosure and adapted to receive a print head such that the print head is exposed to the spray device within the enclosure.

2. The print head parking structure of claim 1 wherein the spray device is adapted to spray at least one of a solvent, a surface treatment solution, and a combination of solvent and surface treatment solution; and
the enclosure is adapted to drain used solvent.

3. The print head parking structure of claim 2, wherein the print head includes a nozzle plate, and the spray device is arranged to direct spray onto the nozzle plate when the print head is in the parking location.

4. The print head parking structure of claim 2, wherein the spray device includes at least two sprayers.

5. The print head parking structure of claim 4, wherein the sprayers are adapted to spray over a wide angle.

6. The print head parking structure of claim 5, wherein the sprayers are adapted to spray over an angle of between about 45 and about 75 degrees.

7. The print head parking structure of claim 3, wherein the spray device is pivotable such that the spray device can be oriented between respective lateral ends of the nozzle plate.

8. The print head parking structure of claim 3, wherein the spray device is movable along a dimension of the nozzle plate.

9. The print head parking structure of claim 1 further comprising a seal adapted to sealably couple the print head parking structure to a print head received at the parking location.

10. A method comprising:
sealing a print head within a parking structure; and
spraying a nozzle plate of the print head with a solvent without getting the solvent on other parts of the print head.

11. The method of claim 10 further comprising draining used solvent from the parking structure without the used solvent contacting the print head.

12. The method of claim 10 wherein sealing the print head within the parking structure includes contacting a surface of the print head with a flexible bellows structure.

13. The method of claim 10 wherein spraying a nozzle plate of the print head with a solvent includes directing a plurality of streams of the solvent at the nozzle plate from a level below the nozzle plate.

14. The method of claim 13 wherein directing the plurality of streams of the solvent includes spraying the plurality of streams intermittently.

15. The method of claim 13 wherein directing the plurality of streams of the solvent includes spraying the plurality of streams via a plurality of oscillating spray devices.

16. A system comprising:
an inkjet printer adapted to manufacture color filters for flat panel displays, the inkjet printer including a plurality of print heads, each print head including a nozzle plate; and
a print head parking structure including an enclosure having a spray device and a parking location adapted to receive a print head such that the nozzle plate of a received print head is exposed to the spray device within the enclosure.

17. The system of claim 16, wherein the spray device is adapted to spray at least one of a solvent, a surface treatment solution, and a combination of solvent and surface treatment solution; and
wherein the enclosure is adapted to drain used solvent.

18. The system of claim 17, wherein the spray device is arranged to direct solvent onto the nozzle plate when the print head is in the parking location.

19. The system of claim 17, wherein the spray device includes at least two sprayers.

20. The system of claim 19, wherein the sprayers are adapted to spray over a wide angle.

21. The system of claim 19, wherein the sprayers are adapted to spray over an angle of between about 45 and about 75 degrees.

22. The system of claim 18, wherein the spray device is pivotable such that the spray device can be oriented between respective lateral ends of the nozzle plate.

23. The system of claim 18, wherein the spray device is movable along a dimension of the nozzle plate.

24. The system of claim 16 further comprising a seal adapted to sealably couple the print head parking structure to a print head received at the parking location.
